(19) United States
(12) Patent Application Publication
(10) Pub. No.: US 2016/0160119 A1
(43) Pub. Date: Jun. 9, 2016

(54) SMART FLUIDS FOR USE IN HYDRAULIC FRACTURING

(71) Applicant: CARBO CERAMICS INC., Houston, TX (US)

(72) Inventors: Chad Cannan, Cypress, TX (US); Lewis Bartel, Albuquerque, NM (US)

(21) Appl. No.: 14/961,038

(22) Filed: Dec. 7, 2015

Related U.S. Application Data
(60) Provisional application No. 62/088,967, filed on Dec. 8, 2014.

(51) Int. Cl. C09K 8/70; E21B 43/26; E21B 43/267; C09K 8/80

(52) U.S. Cl. CPC C09K 8/70; C09K 8/80; E21B 43/26; E21B 43/267; C09K 2208/04; C09K 2208/10

(57) ABSTRACT

Smart fluids for use in hydraulic fracturing are disclosed herein. The smart fluids can include a first particulate component containing a magnetic material and a second particulate component having a permeability and a conductivity. The first particulate component and the second particulate component can be mixed with a fluid selected from the group of water, mineral oil, and glycol and any mixture thereof. The first particulate component can include one or more nanoparticles, including one or more nanowires, formed from the magnetic material. The second particulate component can have a size from about 4 mesh to about 120 mesh.

### CROSS-REFERENCE TO RELATED APPLICATION

The present application claims priority to, and the benefit of the filing date of, U.S. Patent Application No. 62/088,967, filed Dec. 8, 2014, the entire disclosure of which is hereby incorporated herein by reference.

### TECHNICAL FIELD

The present invention relates to methods for hydraulically fracturing an oil or gas well. More particularly, the present invention relates to methods for hydraulically fracturing an oil or gas well with a smart fluid.

### BACKGROUND

In order to stimulate and more effectively produce hydrocarbons from oil and gas bearing formations, and especially formations with low porosity and/or low permeability, induced fracturing (called “frac operations”, “hydraulic fracturing”, or simply “fracing”) of the hydrocarbon-bearing formations has been a commonly used technique. In a typical hydraulic fracturing operation, fluid slurries are pumped downhole under high pressure, causing the formations to fracture around the borehole, creating high permeability conduits that promote the flow of the hydrocarbons into the borehole. The high pressure fluids exit the borehole via perforations through the casing and surrounding cement, and cause the oil and gas formations to fracture, usually in thin, generally vertical sheet-like fractures in the deeper formations in which oil and gas are commonly found. The high pressure fluids typically contain particulate materials called proppant that is generally composed of sand, resin-coated sand or ceramic particles. After the proppant has been placed in the fracture and the fluid pressure relaxed, the fracture is prevented from completely closing by the presence of the proppants.

The proppants introduced to the formation can have a tendency to pool or collect at the bottom of a fracture of the formation, known as “slugging.” Slugging is oftentimes addressed by placing one or more thickening agents in the fluid to promote suspension of the proppant material, thereby reducing the likelihood of slugging in the formation. The thickening agents, however, can breakdown under the high temperatures of downhole conditions. Also, thickening agents include chemicals which may be subject to future environmental regulations.

It would be desirable to thicken a hydraulic fluid without potentially harmful chemicals that can breakdown under the high temperatures and pressures often found in well formations.

### SUMMARY

A composition for use in hydraulic fracturing is disclosed herein. The composition can include a first particulate component containing a magnetic material and a second particulate component having a permeability and a conductivity. The first particulate component and the second particulate component can be mixed with a fluid selected from the group of water, mineral oil, and glycol and any mixture thereof. The first particulate component can include one or more nanoparticles, including one or more nanowires, formed from the magnetic material. The second particulate component can have a size from about 4 mesh to about 120 mesh and a long term permeability at 7,500 psi of at least about 10 Darcies.

A smart fluid for use in hydraulic fracturing is also disclosed herein. The smart fluid can include a first particulate component containing magnetic nanoparticles and a second particulate component containing a plurality of proppant particulates having a size from about 4 mesh to about 120 mesh. The first particulate component and the second particulate component can be suspended in a solution and an application of a magnetic field or an electric field to the smart fluid can increase the viscosity of the smart fluid. The plurality of nanoparticles can be formed from iron oxide, cobalt oxide, nickel oxide, or gadolinium oxide or any mixture thereof. The second particulate component can be selected from the group consisting of lightweight synthetic ceramic proppant, intermediate strength synthetic ceramic proppant, high strength synthetic ceramic proppant, sand, porous synthetic ceramic proppant, glass beads, and walnut hulls and any mixture thereof.

A method of hydraulic fracturing is also disclosed herein. The method can include injecting a hydraulic fluid into a wellbore and a subterranean formation at a rate and pressure sufficient to open a fracture in the subterranean formation and injecting a smart fluid containing a first particulate component and a second particulate component into the fracture. The first particulate component can include magnetic nanoparticles, and the second particulate component can include a plurality of proppant particulates having a size from about 4 mesh to about 120 mesh. The method can further include lowering a downhole tool down the wellbore prior to injecting the smart fluid into the fracture, emitting a magnetic field from the downhole tool and onto the smart fluid in the fracture, and increasing a viscosity of the smart fluid in the fracture. The method can also include emitting an electric field from the surface and onto the smart fluid in the fracture via a conductive well casing and increasing a viscosity of the smart fluid in the fracture.

### DETAILED DESCRIPTION

In the following description, numerous specific details are set forth. However, it is understood that embodiments of the invention may be practiced without these specific details. In other instances, well-known structures and techniques have not been shown or described in detail in order not to obscure the understanding of this description.

The term “apparent specific gravity,” as used herein, is the weight per unit volume (grams per cubic centimeter) of the particles, including the internal porosity. The apparent specific gravity values given herein were determined by the Archimedes method of liquid (water) displacement according to API RP60, a method which is well known to those of ordinary skill in the art. For purposes of this disclosure, methods of testing the characteristics of the proppant in terms of apparent specific gravity are the standard API tests that are routinely performed on proppant samples.

The term “conductivity,” as used herein, is defined as the product of the width of the created fracture and the permeability of the proppant that remains in the fracture.

The term “high density proppant,” as used herein, means a proppant having an apparent specific gravity of greater than 3.4 g/cm³.

The term “intermediate density proppant,” as used herein, means a proppant having an apparent specific gravity of from 3.0 to 3.4 g/cm³.

The term “light weight proppant,” as used herein, means a proppant having an apparent specific gravity of less than 3.0 g/cm³.

The term “ceramic,” as used herein, means any non-metallic, inorganic solid material.

The term “synthetic ceramic proppant,” as used herein, means any man-made or synthetic ceramic particulate(s).

The term “proppant,” as used herein, means material that includes one or more (e.g., tens, hundreds, thousands, millions, or more) of individual proppant particles, particulates or elements.

The term “nanoparticle,” as used herein, means a particle having at least one dimension between 1 and 100 nanometers.

The term “degradable,” as used herein, means the ability of a chemical or coating to react to dissolve or breakdown into smaller components under one or more downhole conditions.

The term “smart fluid,” as used herein, means a fluid whose properties, for example, viscosity, changes substantially in response to a magnetic field or an electric field.

The term “initial viscosity,” as used herein, means a viscosity of the smart fluid when no external electrical field or magnetic field is applied to the smart fluid.

According to certain embodiments of the present invention, a smart fluid for use in hydraulic fracturing is provided. The smart fluid can include a first particulate component and a second particulate component. The first particulate component can be or include a magnetic material and the second particulate component can be or include a material suitable for use as a proppant.

The first particulate component can be or include any suitable magnetic material. In one or more exemplary embodiments, the first particulate component can be or include any suitable metallic and/or non-metallic material. The first particulate component can be or include any metal selected from Groups 3-12 of the Periodic Table or any oxides thereof. For example, the first particulate component can be or include iron, cobalt, nickel, gadolinium, or oxides thereof, or any combination or mixture thereof The first particulate component can also be or include ferromagnetic particles.

The first particulate component can survive or remain stable under any suitable downhole conditions. According to several exemplary embodiments, the first particulate component is survivable under downhole conditions. According to several exemplary embodiments, the first particulate component is survivable under temperatures of at least about 100° C., at least about 125° C., at least about 150° C., or at least about 300° C. In one or more embodiments, the first particulate component is survivable at temperatures of about 80° C., about 120° C., about 160° C., or about 200° C. to about 250° C., about 300° C., about 350° C., or about 400° C. In one or more embodiments, the first particulate component downhole conditions do not degrade the first particulate component. According to several exemplary embodiments, the first particulate component does not degrade due to being under temperatures of at least about 100° C., at least about 125° C., at least about 150° C., or at least about 300° C. In one or more embodiments, the first particulate component does not degrade due to being at temperatures of about 80° C., about 120° C., about 160° C., or about 200° C. to about 250° C., about 300° C., about 350° C., or about 400° C.

Particulates of the first particulate component can have any suitable size. The particulates of the first particulate component can have a size from about 1 nanometers (nm), about 5 nm, about 10 nm, about 50 nm, about 100 nm, or about 500 nm in their largest dimension. For example, the particulates of the first particulate component can be from about 2 nm to about 500 nm, about 25 nm to about 450 nm, about 150 nm to about 400, about 250 nm to about 350 nm, or about 275 nm to about 325 nm in their largest dimension. The particulates of the first particulate component can be or include nanoparticles. According to several exemplary embodiments, each particulate of the first particulate component is a nanoparticle. In one or more exemplary embodiments, the nanoparticle is a nanowire.

The smart fluid can include the first particulate component in any suitable amounts. The first particulate component can be present in amounts of at least about 0.001 wt %, at least about 0.01 wt %, at least about 0.05 wt %, at least about 0.1 wt %, at least about 0.5 wt %, at least about 1 wt %, at least about 3 wt %, or at least about 6 wt % or more based on the total weight of the smart fluid. According to several exemplary embodiments, the first particulate component can be present in amounts from about 0.001 wt %, about 0.005 wt %, about 0.01 wt %, about 0.05 wt %, about 0.1 wt %, about 0.2 wt %, about 0.5 wt %, or about 1 wt % to about 2 wt %, about 3 wt %, about 5 wt %, about 8 wt %, or about 10 wt % or more based on the total weight of the smart fluid.

The second particulate component can include any material suitable for use as a proppant. For example, the second particulate component can be or include proppant particulates. Suitable proppant particulates can be any one or more of lightweight synthetic ceramic proppant, intermediate strength synthetic ceramic proppant, high strength synthetic ceramic proppant, natural frac sand, porous synthetic ceramic proppant, glass beads, natural proppant such as walnut hulls, and any other man-made, natural, ceramic or glass proppant. According to several exemplary embodiments, the proppant particulates include silica and/or alumina in any suitable amounts. According to several exemplary embodiments, the proppant particulates include less than 80 wt %, less than 60 wt %, less than 40 wt %, less than 30 wt %, less than 20 wt %, less than 10 wt %, or less than 5 wt % silica based on the total weight of the proppant particulates. According to several exemplary embodiments, the proppant particulates include from about 0.1 wt % to about 70 wt % silica, from about 1 wt % to about 60 wt % silica, from about 2.5 wt % to about 50 wt % silica, from about 5 wt % to about 40 wt % silica, or from about 10 wt % to about 30 wt % silica. According to several exemplary embodiments, the proppant particulates include at least about 30 wt %, at least about 40 wt %, at least about 45 wt %, at least about 50 wt %, at least about 60 wt %, at least about 70 wt %, at least about 80 wt %, at least about 90 wt %, or at least about 95 wt % alumina based on the total weight of the proppant particulates. According to several exemplary embodiments, the proppant particulates include from about 30 wt % to about 99.9 wt % alumina, from about 40 wt % to about 99 wt % alumina, from about 50 wt % to about 97 wt % alumina, from about 60 wt % to about 95 wt % alumina, or from about 70 wt % to about 90 wt % alumina.

According to several exemplary embodiments, the proppant particulates are substantially round and spherical having a size in a range between about 6 and 270 U.S. Mesh. For example, the size of the particulates can be expressed as a grain fineness number (GFN) in a range of from about 15 to about 300, or from about 30 to about 110, or from about 40 to about 70. According to such examples, a sample of sintered particulates can be screened in a laboratory for separation by size, for example, intermediate sizes between 20, 30, 40, 50, 70, 100, 140, 200, and 270 U.S. mesh sizes to determine GFN. The correlation between sieve size and GFN can be determined according to Procedure 106-87-S of the American Foundry Society Mold and Core Test Handbook, which is known to those of ordinary skill in the art.

According to several exemplary embodiments, the proppant particulates have any suitable size. For example, the proppant particulates can have a mesh size of at least about 6 mesh, at least about 10 mesh, at least about 16 mesh, at least about 20 mesh, at least about 25 mesh, at least about 30 mesh, at least about 35 mesh, or at least about 40 mesh. According to several exemplary embodiments, the proppant particulates have a mesh size from about 6 mesh, about 10 mesh, about 16 mesh, or about 20 mesh to about 25 mesh, about 30 mesh, about 35 mesh, about 40 mesh, about 45 mesh, about 50 mesh, about 70 mesh, or about 100 mesh. According to several exemplary embodiments, the proppant particulates have a mesh size from about 4 mesh to about 120 mesh, from about 10 mesh to about 60 mesh, from about 16 mesh to about 20 mesh, from about 20 mesh to about 40 mesh, or from about 25 mesh to about 35 mesh.

According to several exemplary embodiments, the proppant particulates have any suitable shape. The proppant particulates can be substantially round, cylindrical, square, rectangular, elliptical, oval, egg-shaped, or pill-shaped. For example, the proppant particulates can be substantially round and spherical. According to several exemplary embodiments, the proppant particulates have an apparent specific gravity of less than 3.1 g/cm³, less than 3.0 g/cm³, less than 2.8 g/cm³, less than 2.5 g/cm³ less than 2.2 g/cm³, or less than 1.9 g/cm³. According to several exemplary embodiments, the proppant particulates have an apparent specific gravity of from, about 1.6 to about 4.5 g/cm³, about 1.8 to about 2.6 g/cm³ about 2.3 to about 3.2 g/cm³, or about 3.1 to 3.4 g/cm³. According to several exemplary embodiments, the proppant particulates have an apparent specific gravity of greater than 3.4 g/cm³, greater than 3.6 g/cm³, greater than 4.0 g/cm³, or greater than 4.5 g/cm³.

According to several exemplary embodiments, the proppant particulates can be or include porous proppant particulates having any suitable porosity. The porous proppant particulates can include an internal interconnected porosity from about 1%, about 2%, about 4%, about 6%, about 8%, about 10%, about 12%, or about 14% to about 18%, about 20%, about 22%, about 24%, about 26%, about 28%, about 30%, about 34%, about 38%, or about 45% or more. In several exemplary embodiments, the internal interconnected porosity of the porous proppant particulates is from about 5 to about 35%, about 5 to about 15%, or about 15 to about 35%. According to several exemplary embodiments, the porous proppant particulates have any suitable average pore size. The porous proppant particulates can have an average pore size that is at least larger than the size of the tracer component in its largest dimension. For example, the porous proppant particulates can have an average pore size from about 2 nm, about 10 nm, about 15 nm, about 55 nm, about 110 nm, about 520 nm, or about 1,100 to about 2,200 nm, about 5,500 nm, about 11,000 nm, about 17,000 nm, or about 25,000 nm or more in its largest dimension. For example, the porous proppant particulates can have an average pore size can be from about 3 nm to about 30,000 nm, about 30 nm to about 18,000 nm, about 200 nm to about 9,000, about 350 nm to about 4,500 nm, or about 850 nm to about 1,800 nm in its largest dimension.

According to several exemplary embodiments, the proppant particulates have any suitable permeability and conductivity in accordance with ISO 13503-5: “Procedures for Measuring the Long-term Conductivity of Proppants,” and expressed in terms of Darcy units, or Darcies (D). For example, the proppant particulates can have a long term permeability at 7,500 psi of at least about 1 D, at least about 2 D, at least about 5 D, at least about 10 D, at least about 20 D, at least about 40 D, at least about 80 D, at least about 120 D, or at least about 150 D. The proppant particulates can have a long term permeability at 12,000 psi of at least about 1 D, at least about 2 D, at least about 3 D, at least about 4 D, at least about 5 D, at least about 10 D, at least about 25 D, or at least about 50 D. The proppant particulates can have a long term conductivity at 7,500 psi of at least about 100 millidarcy-feet (mD-ft), at least about 200 mD-ft, at least about 300 mD-ft, at least about 500 mD-ft, at least about 1,000 mD-ft, at least about 1,500 mD-ft, at least about 2,000 mD-ft, or at least about 2,500 mD-ft. For example, the proppant particulates can have a long term conductivity at 12,000 psi of at least about 50 mD-ft, at least about 100 mD-ft, at least about 200 mD-ft, at least about 300 mD-ft, at least about 500 mD-ft, at least about 1,000 mD-ft, or at least about 1,500 mD-ft.

According to several exemplary embodiments, at least a portion of the proppant particulates are coated with a resin material. One or more of the proppant particulates can be coated with the resin material. According to several exemplary embodiments, at least about 50%, at least about 75%, at least about 85%, at least about 90%, at least about 95%, or least about 99% of the proppant particulates are coated with the resin material. In one or more exemplary embodiments, all of the proppant particulates can be coated with the resin material.

According to several exemplary embodiments, at least a portion of the surface area of each of the coated proppant particulates is covered with the resin material. According to several exemplary embodiments, at least about 10%, at least about 25%, at least about 50%, at least about 75%, at least about 90%, at least about 95%, or at least about 99% of the surface area of the coated proppant particulates is covered with the resin material. According to several exemplary embodiments, about 40% to about 99.9%, about 85% to about 99.99%, or about 98% to about 100% of the surface area of the coated proppant particulates is covered with the resin material. According to several exemplary embodiments, the entire surface area of the coated proppant particulates is covered with the resin material. For example, the coated proppant particulates can be encapsulated by the resin material.

According to several exemplary embodiments, the resin material is present on the resin coated proppant particulates in any suitable amount. According to several exemplary embodiments, the resin coated proppant particulates contain at least about 0.1 wt % resin, at least about 0.5 wt % resin, at least about 1 wt % resin, at least about 2 wt % resin, at least about 4 wt % resin, at least about 6 wt % resin, at least about 10 wt % resin, or at least about 20 wt % resin, based on the total weight of the resin coated proppant particulates. According to several exemplary embodiments, the resin coated proppant particulates contain about 0.01 wt %, about 0.2 wt %, about 0.8 wt %, about 1.5 wt %, about 2.5 wt %, about 3.5 wt %, or about 5 wt % to about 8 wt %, about 15 wt %, about 30 wt %, about 50 wt %, or about 80 wt % resin, based on the total weight of the resin coated proppant particulates.

According to several exemplary embodiments, the resin material includes any suitable resin. For example, the resin material can include a phenolic resin, such as a phenol-formaldehyde resin. According to several exemplary embodiments, the phenol-formaldehyde resin has a molar ratio of formaldehyde to phenol (F:P) from a low of about 0.6: 1, about 0.9: 1, or about 1.2:1 to a high of about 1.9:1, about 2.1:1, about 2.3:1, or about 2.8:1. For example, the phenol-formaldehyde resin can have a molar ratio of formaldehyde to phenol of about 0.7:1 to about 2.7:1, about 0.8:1 to about 2.5:1, about 1:1 to about 2.4:1, about 1.1:1 to about 2.6:1, or about 1.3:1 to about 2:1. The phenol-formaldehyde resin can also have a molar ratio of formaldehyde to phenol of about 0.8:1 to about 0.9:1, about 0.9:1 to about 1:1, about 1:1 to about 1.1:1, about 1.1:1 to about 1.2:1, about 1.2:1 to about 1.3:1, or about 1.3:1 to about 1.4:1.

According to several exemplary embodiments, the phenol-formaldehyde resin has a molar ratio ofless than 1:1, less than 0.9:1, less than 0.8:1, less than 0.7:1, less than 0.6:1, or less than 0.5:1. For example, the phenol-formaldehyde resin can be or include a phenolic novolac resin. Phenolic novolac resins are well known to those of ordinary skill in the art, for instance see U.S. Pat. No. 2,675,335 to Rankin, U.S. Pat. No. 4,179,429 to Hanauye, U.S. Pat. No. 5,218,038 to Johnson, and U.S. Pat. No. 8,399,597 to Pullichola, the entire disclosures of which are incorporated herein by reference. Suitable examples of commercially available novolac resins include novolac resins available from Plenco™, Durite® resins available from Momentive, and novolac resins available from S.I. Group.

According to several exemplary embodiments, the phenol-formaldehyde resin has a weight average molecular weight from a low of about 200, about 300, or about 400 to a high of about 1,000, about 2,000, or about 6,000. For example, the phenol-formaldehyde resin can have a weight average molecular weight from about 250 to about 450, about 450 to about 550, about 550 to about 950, about 950 to about 1,500, about 1,500 to about 3,500, or about 3,500 to about 6,000. The phenol-formaldehyde resin can also have a weight average molecular weight of about 175 to about 800, about 700 to about 3,330, about 1,100 to about 4,200, about 230 to about 550, about 425 to about 875, or about 2,750 to about 4,500.

According to several exemplary embodiments, the phenol-formaldehyde resin has a number average molecular weight from a low of about 200, about 300, or about 400 to a high of about 1,000, about 2,000, or about 6,000. For example, the phenol-formaldehyde resin can have a number average molecular weight from about 250 to about 450, about 450 to about 550, about 550 to about 950, about 950 to about 1,500, about 1,500 to about 3,500, or about 3,500 to about 6,000. The phenol-formaldehyde resin can also have a number average molecular weight of about 175 to about 800, about 700 to about 3,000, about 1,100 to about 2,200, about 230 to about 550, about 425 to about 875, or about 2,000 to about 2,750.

According to several exemplary embodiments, the phenol-formaldehyde resin has a z-average molecular weight from a low of about 200, about 300, or about 400 to a high of about 1,000, about 2,000, or about 9,000. For example, the phenol-formaldehyde resin can have a z average molecular weight from about 250 to about 450, about 450 to about 550, about 550 to about 950, about 950 to about 1,500, about 1,500 to about 3,500, about 3,500 to about 6,500, or about 6,500 to about 9,000. The phenol-formaldehyde resin can also have a z-average molecular weight of about 175 to about 800, about 700 to about 3,330, about 1,100 to about 4,200, about 230 to about 550, about 425 to about 875, or about 4,750 to about 8,500.

According to several exemplary embodiments, the phenol-formaldehyde resin has a polydispersity index from a low of about 1, about 1.75, or about 2.5 to a high of about 2.75, about 3.5, or about 4.5. For example, the phenol-formaldehyde resin can have a polydispersity index from about 1 to about 1.75, about 1.75 to about 2.5, about 2.5 to about 2.75, about 2.75 to about 3.25, about 3.25 to about 3.75, or about 3.75 to about 4.5. The phenol-formaldehyde resin can also have a polydispersity index of about 1 to about 1.5, about 1.5 to about 2.5, about 2.5 to about 3, about 3 to about 3.35, about 3.35 to about 3.9, or about 3.9 to about 4.5.

According to several exemplary embodiments, the phenol-formaldehyde resin has any suitable viscosity. The phenol-formaldehyde resin can be a solid or liquid at 25° C. For example, the viscosity of the phenol-formaldehyde resin can be from about 1 centipoise (cP), about 100 cP, about 250 cP, about 500 cP, or about 700 cP to about 1,000 cP, about 1,250 cP, about 1,500 cP, about 2,000 cP, or about 2,200 cP at a temperature of about 25° C. In another example, the phenol-formaldehyde resin can have a viscosity from about 1 cP to about 125 cP, about 125 cP to about 275 cP, about 275 cP to about 525 cP, about 525 cP to about 725 cP, about 725 cP to about 1,100 cP, about 1,100 cP to about 1,600 cP, about 1,600 cP to about 1,900 cP, or about 1,900 cP to about 2,200 cP at a temperature of about 25° C. In another example, the phenol-formaldehyde resin can have a viscosity from about 1 cP to about 45 cP, about 45 cP to about 125, about 125 cP to about 550 cP, about 550 cP to about 825 cP, about 825 cP to about 1,100 cP, about 1,100 cP to about 1,600 cP, or about 1,600 cP to about 2,200 cP at a temperature of about 25° C. The viscosity of the phenol-formaldehyde resin can also be from about 500 cP, about 1,000 cP, about 2,500 cP, about 5,000 cP, or about 7,500 cP to about 10,000 cP, about 15,000 cP, about 20,000 cP, about 30,000 cP, or about 75,000 cP at a temperature of about 150° C. For example, the phenol-formaldehyde resin can have a viscosity from about 750 cP to about 60,000 cP, about 1,000 cP to about 35,000 cP, about 4,000 cP to about 25,000 cP, about 8,000 cP to about 16,000 cP, or about 10,000 cP to about 12,000 cP at a temperature of about 150° C. The viscosity of the phenol-formaldehyde resin can be determined using a Brookfield viscometer.

According to several exemplary embodiments, the phenol-formaldehyde resin can have pH from a low of about 1, about 2, about 3, about 4, about 5, about 6, about 7 to a high of about 8, about 9, about 10, about 11, about 12, or about 13. For example, the phenol-formaldehyde resin can have a pH from about 1 to about 2.5, about 2.5 to about 3.5, about 3.5 to about 4.5, about 4.5 to about 5.5, about 5.5 to about 6.5, about 6.5 to about 7.5, about 7.5 to about 8.5, about 8.5 to about 9.5, about 9.5 to about 10.5, about 10.5 to about 11.5, about 11.5 to about 12.5, or about 12.5 to about 13.

According to several exemplary embodiments of the present invention, the resin coating applied to the proppant particulates is an epoxy resin. According to such embodiments, the resin coating can include any suitable epoxy resin. For example, the epoxy resin can include bisphenol A, bisphenol F, aliphatic, or glycidylamine epoxy resins, and any mixtures or combinations thereof. An example of a commercially available epoxy resin is BE188 Epoxy Resin, available from Chang Chun Plastics Co., Ltd.

According to several exemplary embodiments, the epoxy resin can have any suitable viscosity. The epoxy resin can be a solid or liquid at 25° C. For example, the viscosity of the epoxy resin can be from about 1 cP, about 100 cP, about 250 cP, about 500 cP, or about 700 cP to about 1,000 cP, about 1,250 cP, about 1,500 cP, about 2,000 cP, or about 2,200 cP at a temperature of about 25° C. In another example, the epoxy resin can have a viscosity from about 1 cP to about 125 cP, about 125 cP to about 275 cP, about 275 cP to about 525 cP, about 525 cP to about 725 cP, about 725 cP to about 1,100 cP, about 1,100 cP to about 1,600 cP, about 1,600 cP to about 1,900 cP, or about 1,900 cP to about 2,200 cP at a temperature of about 25° C. In another example, the epoxy resin can have a viscosity from about 1 cP to about 45 cP, about 45 cP to about 125 cP, about 125 cP to about 550 cP, about 550 cP to about 825 cP, about 825 cP to about 1,100 cP, about 1,100 eP to about 1,600 cP, or about 1,600 cP to about 2,200 cP at a temperature of about 25° C. The viscosity of the epoxy resin can also be from about 500 cP, about 1,000 eP, about 2,500 cP, about 5,000 cP, or about 7,000 cP to about 10,000 cP, about 12,500 cP, about 15,000 cP, about 17,000 cP, or about 20,000 cP at a temperature of about 25° C. In another example, the epoxy resin can have a viscosity from about 1,000 cP to about 12,000 cP, about 2,000 cP to about 11,000 cP, about 4,000 cP to about 10,500 cP, or about 7,500 cP to about 9,500 cP at a temperature of about 25° C. The viscosity of the epoxy resin can also be from about 500 cP, about 1,000 cP, about 2,500 cP, about 5,000 cP, or about 7,500 cP to about 10,000 cP, about 15,000 cP, about 20,000 cP, about 30,000 cP, or about 75,000 cP at a temperature of about 150° C. For example, the epoxy resin can have a viscosity from about 750 cP to about 60,000 cP, about 1,000 cP to about 35,000 cP, about 4,000 cP to about 25,000 cP, about 8,000 cP to about 16,000 cP, or about 10,000 cP to about 12,000 cP at a temperature of about 150° C.

According to several exemplary embodiments, the epoxy resin can have pH from a low of about 1, about 2, about 3, about 4, about 5, about 6, about 7 to a high of about 8, about 9, about 10, about 11, about 12, or about 13. For example, the epoxy resin can have a pH from about 1 to about 2.5, about 2.5 to about 3.5, about 3.5 to about 4.5, about 4.5 to about 5.5, about 5.5 to about 6.5, about 6.5 to about 7.5, about 7.5 to about 8.5, about 8.5 to about 9.5, about 9.5 to about 10.5, about 10.5 to about 11.5, about 11.5 to about 12.5, or about 12.5 to about 13.

Methods for coating proppant particulates with resins are well known to those of ordinary skill in the art, for instance see U.S. Pat. No. 2,378,817 to Wrightsman, U.S. Pat. No. 4,873,145 to Okada and U.S. Pat. No. 4,888,240 to Graham, the entire disclosures of which are incorporated herein by reference.

According to several exemplary embodiments of the present invention, a curing agent is applied to the resin-coated proppant particulates in order to accelerate the transition of the resin from a liquid to a solid state. Suitable curing agents include curing agents that will leave active amine or epoxy sites on the surface of the resin coating. Suitable curing agents will depend on the specific resin chemistry employed and can include amines, acids, acid anhydrides, and epoxies. In several exemplary embodiments of the present invention, a phenolic resin material is applied to the surface of the proppant particulates and cured with an amine curing agent in order to leave active amine sites on the resin coated surface of the proppant particulates. In several exemplary embodiments, the phenolic resin is cured with hexamethylenetetramine, also known as hexamine. An example of a commercially available hexamine is Hexion™; which is available from Momentive.

The smart fluid can include proppant in any suitable amounts. The second particulate component can be present in amounts of at least about 0.01 wt %, at least about 0.05 wt %, at least about 0.1 wt %, at least about 0.5 wt %, at least about 1 wt %, at least about 2 wt %, at least about 5 wt %, or at least about 10 wt % or more based on the total weight of the smart fluid. The proppant can be present in amounts from about 1 wt %, about 3 wt %, about 5 wt %, or about 7 wt % to about 9 wt %, about 12 wt %, about 14 wt %, about 16 wt %, about 18 wt % or more based on the total weight of the smart fluid.

In addition to the first and second particulate components described above, the smart fluid can also contain water, one or more tracers, scale inhibitors, hydrate inhibitors, hydrogen sulfide scavenging materials, corrosion inhibitors, paraffin or wax inhibitors, including ethylene vinyl acetate copolymers, asphaltene inhibitors, organic deposition inhibitors, biocides, demulsifiers, defoamers, gel breakers, salt inhibitors, oxygen scavengers, iron sulfide scavengers, iron scavengers, clay stabilizers, enzymes, biological agents, flocculants, naphthenate inhibitors, carboxylate inhibitors, nanoparticle dispersions, surfactants, combinations thereof, or any other oilfield chemical that may be deemed helpful in the hydraulic fracturing process and hydrocarbons, such as mineral oil, glycol, naphtha, kerosene, and diesel. The smart fluid can be an aqueous solution containing water in any suitable amounts. The water can be present in amounts from about 20 wt %, about 35 wt %, about 45 wt %, about 55 wt %, about 65 wt %, about 75 wt %, or about 85 wt % to about 90 wt %, about 92 wt %, about 94 wt %, about 96 wt %, about 98 wt % or more based on the total weight of the smart fluid. The water used to form the aqueous solution can be fresh water, saltwater, brine, or any other aqueous liquid. The smart fluid can also be a non-aqueous solution, or organic phase solution. In one or more embodiments, the smart fluid can include mineral oil in amounts from about 20 wt %, about 35 wt %, about 45 wt %, about 55 wt %, about 65 wt %, about 75 wt %, or about 85 wt % to about 90 wt %, about 92 wt %, about 94 wt %, about 96 wt %, about 98 wt % or more based on the total weight of the smart fluid. The smart fluid can also include glycol in amounts from about 20 wt %, about 35 wt %, about 45 wt %, about 55 wt %, about 65 wt %, about 75 wt %, or about 85 wt % to about 90 wt %, about 92 wt %, about 94 wt %, about 96 wt %, about 98 wt % or more based on the total weight of the smart fluid.

The smart fluid can have any suitable initial viscosity. The initial viscosity of the smart fluid can be from about 0.1 cP, about 0.5 cP, about 0.75 cP, about 0.85 cP, or about 0.95 cP to about 1.1 cP, about 1.25 cP, about 1.5 cP, about 2 cP, or about 5 cP at a temperature of about 25° C. In one or more exemplary embodiments, the initial viscosity of the smart fluid is about 0.8 cP, about 1 cP, or about 1.2 cP at a temperature of about 25° C. The initial viscosity of the smart fluid can also be from about 1 cP, about 5 cP, about 7 cP, about 10 cP, or about 15 cP to about 20 cP, about 25 cP, about 30 cP, about 35 cP, about 45 cP, about 50 cP, about 60 cP, or about 75 cP at a temperature of about 25° C. For example, the initial viscosity of the smart fluid can be from about 2 cP to about 40 cP, from about 6 cP to about 35 cP, or from about 12 cP to about 30 cP at a temperature of about 25° C.

Methods for using the smart fluid in any suitable hydraulic fracturing operation are disclosed herein. In a hydraulic fracturing operation, the smart fluid can be introduced into a wellbore at a pressure sufficient to lodge at least a portion of the second particulate component into one or more fractures of a subterranean formation adjacent the wellbore. For example, a method of hydraulic fracturing can include introducing the smart fluid into a fracture of a subterranean formation such that at least a portion of the second particulate component props open the one or more subterranean fractures.

The viscosity of the smart fluid can be increased by subjecting the smart fluid to a magnetic field or an electric field. The magnetic field and/or electric field can be generated downhole and/or on the surface. In one or more embodiments, the magnetic field and/or electric field can be generated on the surface and the magnetic field and/or electric field can be delivered downhole via the casing disposed in the wellbore. In one or more embodiments, the magnetic field and/or electric field can be emitted from a downhole tool, such as a wireline tool. For example, electric current can be carried down a wellbore to an energizing point which will generally be located within 10 meters or more (above or below) of perforations in a casing via a wireline cable, such as those which are well known to those of ordinary skill in the art and are widely commercially available from Camesa Wire, Rochester Wire and Cable, Inc., WireLine Works, Novametal Group, and Quality Wireline & Cable Inc. In one or more embodiments, a sinker bar can be connected to the wireline cable. The sinker bar can contact or be in close proximity to the well casing whereupon the well casing becomes a current line source that produces subsurface magnetic field and/or electric field. This magnetic field and/or electric field can interact with the smart fluid to increase the viscosity of the smart fluid.

The magnetic field can be applied to the smart fluid at any stage of the hydraulic fracturing process. For example, the magnetic field can be applied before, during, or after injecting the smart fluid down a wellbore. In one or more embodiments, the smart fluid is subjected to the magnetic field as the smart fluid flows into the one or more fractures of the subterranean formation. The smart fluid can also be subjected to the magnetic field after flowing into the one or more fractures. For example, the magnetic field can be applied to the smart fluid when the smart fluid is inside a subterranean fracture having a length extending from the wellbore to the formation. In one or more embodiments, the magnetic field can be applied to the smart fluid in any direction relative to the length of the fracture containing the smart fluid. The smart fluid can be applied in a direction perpendicular to the length of the fracture. The smart fluid can also be applied in a direction parallel to the length of the fracture. In one or more embodiments, the magnetic field is applied to the fracture containing the smart fluid in a direction of about 5 degrees, about 10 degrees, about 15 degrees, about 25 degrees, about 35 degrees, or about 40 degrees to about 50 degrees, about 60 degree, about 70 degrees, about 80 degrees or about 90 degrees from an axis extending along the length of the fracture.

The magnetic field can be applied to the smart fluid in any suitable amounts. For example, the magnetic field applied to the smart fluid can be at least about 0.01 tesla (T), at least about 0.05 T, at least about 0.1 T, at least about 0.2 T, at least about 0.5 T, or at least about 0.7 T. The magnetic field applied to the smart fluid can be about 0.025 T to about 10 T, about 0.075 T to about 7 T, about 0.1 T to about 5 T, about 0.3 T to about 3 T, about 0.5 T to about 1.5 T, or about 0.6 T to about 0.9 T.

The viscosity of the smart fluid being subjected to the magnetic field can be from about 50 cP, about 100 cP, about 250 cP, about 500 cP, about 1,000 cP, about 2,500 cP, about 5,000 cP, or about 10,000 cP to about 20,000 cP, about 50,000 cP, about 100,000 cP, about 200,000 cP, about 500,000 cP, or about 1,000,000 cP at a temperature of about 25° C. In one or more exemplary embodiments, the viscosity of the smart fluid subjected to the magnetic field can be from about 2,000 cP to about 750,000 cP, about 3,000 cP to about 300,000 cP, or about 5,000 cP to about 100,000 cP at a temperature of about 25° C. In one or more embodiments, the magnetic field can increase the viscosity of the smart fluid by at least about 5%, at least about 15%, at least about 25%, at least about 50%, at least about 100%, at least about 200%, at least about 300%, or at least about 500%. For example, the application of the magnetic field to the smart fluid can increase the viscosity of the smart fluid by about 1%, about 5%, about 10%, about 15%, about 20%, or about 25% to about 35%, about 45%, about 55%, about 65%, about 75%, about 85%, about 100%, about 150%, about 250%, about 350%, or about 700%.

In one or more exemplary embodiments, the strength of the magnetic field can be varied or adjusted to increase and/or decrease the viscosity of the smart fluid by any suitable amount. In one or more exemplary embodiments, the strength of the magnetic field can be adjusted to increase the viscosity of the smart fluid by at least about 5%, at least about 15%, at least about 25%, at least about 50%, at least about 100%, at least about 200%, at least about 300%, or at least about 500%. For example, the strength of the magnetic field can be adjusted to increase the viscosity of the smart fluid by about 1%, about 5%, about 10%, about 15%, about 20%, or about 25% to about 35%, about 45%, about 55%, about 65%, about 75%, about 85%, about 100%, about 150%, about 250%, about 350%, or about 700%. In one or more exemplary embodiments, the strength of the magnetic field can be adjusted to decrease the viscosity of the smart fluid by at least about 5%, at least about 15%, at least about 25%, at least about 50%, at least about 100%, at least about 200%, at least about 300%, or at least about 500%. For example, the strength of the magnetic field can be adjusted to decrease the viscosity of the smart fluid by about 1%, about 5%, about 10%, about 15%, about 20%, or about 25% to about 35%, about 45%, about 55%, about 65%, about 75%, about 85%, about 100%, about 150%, about 250%, about 350%, or about 700%. The strength of the magnetic field can be varied or adjusted in any suitable manner. For example, an electric current delivered to a downhole tool through a wireline and/or the well casing can be varied and/or adjusted downhole and/or at the surface to adjust the strength of the magnetic field.

An electric field can also be applied to the smart fluid at any stage of the hydraulic fracturing process. For example, the electric field can be applied before, during, or after injecting the smart fluid down a wellbore. In one or more embodiments, the smart fluid is subjected to the electric field as the smart fluid flows into the one or more fractures of the subterranean formation. The smart fluid can also be subjected to the electric field after flowing into the one or more fractures. For example, the electric field can be applied to the smart fluid when the smart fluid is inside a subterranean fracture having a length extending from the wellbore to the formation. In one or more embodiments, the electric field can be applied to the smart fluid in any direction relative to the length of the fracture containing the smart fluid. The smart fluid can be applied in a direction perpendicular to the length of the fracture. The smart fluid can also be applied in a direction parallel to the length of the fracture. In one or more embodiments, the electric field is applied to the fracture containing the smart fluid in a direction of about 5 degrees, about 10 degrees, about 15 degrees, about 25 degrees, about 35 degrees, or about 40 degrees to about 50 degrees, about 60 degrees, about 70 degrees, about 80 degrees or about 90 degrees from an axis extending along the length of the fracture.

The electric field can be applied to the smart fluid in any suitable amounts. For example, the electric field applied to the smart fluid can be at least about 3.0×10⁶ volts per meter (V/m), at least about 1.5×10⁷ V/m, at least about 3.0×10⁷ V/m, at least about 6.0×10⁷ V/m, at least about 1.5×10⁸ V/m, or at least about 2.0×10⁸ V/m. The electric field applied the smart fluid can be about 7.5×10⁶ V/m to about 3.0×10⁹ V/m, about 2.0×10⁷ V/m to about 2.0×10⁹ V/m, about 3.0×10⁷ V/m to about 1.5×10⁹ V/m, about 9.0×10⁷ V/m to about 9.0×10⁸ V/m, about 1.5×10⁸ V/m to about 4.5×10⁸ V/m, or about 1.8×10⁸ V/m to about 2.7×10⁸ V/m.

The viscosity of the smart fluid being subjected to the electric field can be from about 50 cP, about 100 cP, about 250 cP, about 500 cP, about 1,000 cP, about 2,500 cP, about 5,000 cP, or about 10,000 cP to about 20,000 cP, about 50,000 cP, about 100,000 cP, about 200,000 cP, about 500,000 cP, or about 1,000,000 cP at a temperature of about 25° C. In one or more exemplary embodiments, the viscosity of the smart fluid subjected to the electric field can be from about 2,000 cP to about 750,000 cP, about 3,000 cP to about 300,000 cP, or about 5,000 cP to about 100,000 cP at a temperature of about 25° C. In one or more embodiments, the electric field can increase the viscosity of the smart fluid by at least about 5%, at least about 15%, at least about 25%, at least about 50%, at least about 100%, at least about 200%, at least about 300%, or at least about 500%. For example, the application of the electric field to the smart fluid can increase the viscosity of the smart fluid by from about 1%, about 5%, about 10%, about 15%, about 20%, or about 25% to about 35%, about 45%, about 55%, about 65%, about 75%, about 85%, about 100%, about 150%, about 250%, about 350%, or about 700%.

In one or more exemplary embodiments, the strength of the electric field can be varied or adjusted to increase and/or decrease the viscosity of the smart fluid by any suitable amount. In one or more exemplary embodiments, the strength of the electric field can be adjusted to increase the viscosity of the smart fluid by at least about 5%, at least about 15%, at least about 25%, at least about 50%, at least about 100%, at least about 200%, at least about 300%, or at least about 500%. For example, the strength of the electric field can be adjusted to increase the viscosity of the smart fluid by about 1%, about 5%, about 10%, about 15%, about 20%, or about 25% to about 35%, about 45%, about 55%, about 65%, about 75%, about 85%, about 100%, about 150%, about 250%, about 350%, or about 700%. In one or more exemplary embodiments, the strength of the electric field can be adjusted to decrease the viscosity of the smart fluid by at least about 5%, at least about 15%, at least about 25%, at least about 50%, at least about 100%, at least about 200%, at least about 300%, or at least about 500%. For example, the strength of the electric field can be adjusted to decrease the viscosity of the smart fluid by about 1%, about 5%, about 10%, about 15%, about 20%, or about 25% to about 35%, about 45%, about 55%, about 65%, about 75%, about 85%, about 100%, about 150%, about 250%, about 350%, or about 700%. The strength of the electric field can be varied or adjusted in any suitable manner. For example, an electric current delivered to a downhole tool through a wireline and/or the well casing can be varied and/or adjusted downhole and/or at the surface to adjust the strength of the electric field.

In one or more exemplary embodiments, the smart fluid can be used to keep the one or more fractures in an open condition. For example, the electric and/or magnetic field(s) applied to the smart fluid when the smart fluid is in the one or more fractures can provide sufficient force to prop-open or maintain the one or more fractures in an open condition. Removing the electric and/or magnetic field(s) from the smart fluid can cause the one or more fractures to close or close onto a pack of the proppant particulates.

Any suitable amount of the second particulate component can be suspended in the smart fluid inside the one or more fractures. In one or more embodiments, at least about 5 wt %, at least about 15 wt %, at least about 25 wt %, at least about 40 wt %, at least about 50 wt %, at least about 60 wt %, at least about 70 wt %, at least about 80 wt %, at least about 90 wt %, or at least about 95 wt % of the second particulate component is suspended in smart fluid. In one or more embodiments, less than 40 wt %, less than 50 wt %, less than 60 wt %, less than 70 wt %, or less than 80 wt % of the second particulate component is suspended in smart fluid when the smart fluid is not subjected to a magnetic field or an electric field generated downhole or at the surface. In one or more embodiments, at least about 5 wt %, at least about 15 wt %, at least about 25 wt %, at least about 40 wt %, at least about 50 wt %, at least about 60 wt %, at least about 70 wt %, at least about 80 wt %, at least about 90 wt %, or at least about 95 wt % of the second particulate component is suspended in smart fluid when the smart fluid is subjected to the magnetic field. In one or more embodiments, at least about 5 wt %, at least about 15 wt %, at least about 25 wt %, at least about 40 wt %, at least about 50 wt %, at least about 60 wt %, at least about 70 wt %, at least about 80 wt %, at least about 90 wt %, or at least about 95 wt % of the second particulate component is suspended in smart fluid when the smart fluid is subjected to the electric field.

While the present invention has been described in terms of several exemplary embodiments, those of ordinary skill in the art will recognize that the invention can be practiced with modification within the spirit and scope of the appended claims.

The present disclosure has been described relative to a several exemplary embodiments. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A composition for use in hydraulic fracturing, the composition comprising:
a first particulate component comprising a magnetic material; and
a second particulate component, the second particulate component having a permeability and a conductivity, wherein the first particulate component and the second particulate component are mixed with a fluid.

2. The composition of claim 1, wherein the fluid is selected from the group consisting of water, mineral oil, and glycol and any mixture thereof.

3. The composition of claim 1, wherein the first particulate component comprises a plurality of nanoparticles.

4. The composition of claim 3, wherein the plurality of nanoparticles are formed from iron oxide, cobalt oxide, nickel oxide, or gadolinium oxide or any mixture thereof.

5. The composition of claim 4, wherein the nanoparticles are nanowires.

6. The composition of claim 1, wherein the second particulate component comprises a plurality of proppant particulates having a size from about 4 mesh to about 120 mesh.

7. The composition of claim 1, wherein the second particulate component is selected from the group consisting of lightweight synthetic ceramic proppant, intermediate strength synthetic ceramic proppant, high strength synthetic ceramic proppant, sand, porous synthetic ceramic proppant, glass beads, and walnut hulls and any mixture thereof.

8. The composition of claim 1, wherein the second particulate component comprises at least 40 wt % alumina.

9. The composition of claim 1, further comprising a viscosity of about 0.1 cP to about 5 cP at a temperature of about 25° C.

10. The composition of claim 9, wherein the viscosity is about 5,000 cP to about 100,000 cP at a temperature of about 25° C. when the composition is subjected to a magnetic field or an electric field.

11. A smart fluid for use in hydraulic fracturing, comprising:
a first particulate component comprising magnetic nanoparticles; and
a second particulate component comprising a plurality of proppant particulates having a size from about 4 mesh to about 120 mesh, the first particulate component and the second particulate component being suspended in a solution, wherein application of a magnetic field or an electric field to the smart fluid increases the viscosity of the smart fluid.

12. The smart fluid of claim 11, wherein the plurality of nanoparticles are formed from iron oxide, cobalt oxide, nickel oxide, or gadolinium oxide or any mixture thereof.

13. The smart fluid of claim 11, wherein the second particulate component is selected from the group consisting of lightweight synthetic ceramic proppant, intermediate strength synthetic ceramic proppant, high strength synthetic ceramic proppant, sand, porous synthetic ceramic proppant, glass beads, and walnut hulls and any mixture thereof.

14. The composition of claim 11, wherein the viscosity of the smart fluid prior to the application of the magnetic field of the electric field is about 0.1 cP to about 5 cP at a temperature of about 25° C.

15. The composition of claim 14, wherein the viscosity is about 5,000 cP to about 100,000 cP at a temperature of about 25° C. when the composition is subjected to the magnetic field or the electric field.

16. A method of hydraulic fracturing a subterranean formation, comprising:
injecting a hydraulic fluid into a wellbore and a subterranean formation at a rate and pressure sufficient to open a fracture in the subterranean formation; and
injecting a smart fluid containing a first particulate component and a second particulate component into the fracture;
wherein the first particulate component comprises magnetic nanoparticles;
wherein the second particulate component comprises a plurality of proppant particulates having a size from about 4 mesh to about 120 mesh.

17. The method of claim 16, further comprising:
lowering a downhole tool down the wellbore prior to injecting the smart fluid into the fracture;
emitting a magnetic field from the downhole tool and onto the smart fluid in the fracture; and
increasing a viscosity of the smart fluid in the fracture.

18. The method of claim 17, wherein a magnetic field of about 0.1 T to about 0.9 T increases the viscosity by at least about 25%.

19. The method of claim 16, further comprising:
emitting an electric field from the surface and onto the smart fluid in the fracture via a conductive well casing; and
increasing a viscosity of the smart fluid in the fracture.

20. The method of claim 19, wherein an electric field of about 7.5×10⁶ V/m to about 2.7×10⁸ V/m increases the viscosity by at least about 25%.
